(19) United States
(12) Patent Application Publication
(10) Pub. No.: US 2026/0217065 A1
(43) Pub. Date: Jul. 30, 2026

(54) SYSTEMS AND METHODS FOR IN-TIRE WHEEL FORCE TRANSDUCER

(71) Applicants: NITTO BEND TECHNOLOGIES, INC., Farmington, UT (US); NITTO DENKO CORPORATION, Kita-ku, Osaka (JP)

(72) Inventors: Juma Belknap, Reedley, CA (US); John BORTELL, Livonia, MI (US); Nathan Briggs, Farmington, UT (US); Benedicto Delos Santos, San Diego, CA (US); Jared Jonas, Seattle, WA (US); Colton Ottley, Farmington, UT (US); Colin Eichinger, Salt Lake City,, UT (US)

(73) Assignees: NITTO BEND TECHNOLOGIES, INC., Farmington, UT (US); NITTO DENKO CORPORATION, Kita-ku, Osaka (JP)

(21) Appl. No.: 19/148,586

(22) PCT Filed: Jan. 18, 2024
(86) PCT No.: PCT/US2024/012043

§ 371 Date: Jul. 16, 2025

Related U.S. Application Data
(60) Provisional application No. 63/480,391, filed on Jan. 18, 2023.

(51) Int. Cl. B60C 19/00; B60C 23/04; G01M 17/02

(52) U.S. Cl. CPC B60C 19/00; B60C 23/0493; G01M 17/02; B60C 2019/004

(57) ABSTRACT

A sensor module for estimating one or more parameters of a tire, the sensor module including a detector patch comprising a contact patch and a sidewall patch each having one or more extensible capacitors that have an electrostatic capacity that is variable due to at least deformation of the respective one of the contact patch and the sidewall patch, and a power source, an electronics unit in electronic communication with the power source and the detector patch and configured to control the sensor module, and wherein the detector patch is configured to be adhered to an inside of a tire so that the contact patch contacts an inside of a tread portion and the sidewall patch contacts an inside of a sidewall portion and the electronics unit is configured to estimate at least one of the parameters by of the tire using the electrostatic capacity of the one or more extensible capacitors.

### FIELD OF THE DISCLOSURE

This disclosure relates generally vehicular wheel force transducers (WFT). More particularly, this disclosure relates to compliant sensor systems and methods for in-tire sensors configured to detect tire forces and moments.

### BACKGROUND

Flexible sensors are known. For example, U.S. Pat. Nos. 8,941,392; 9,222,764; 9,476,692; 9,612,102; 9,874,431; 10,551,917; 10,823,546; 10,959,644, and U.S. Pat. App. Pub. 2022/0034692, the contents of which are hereby incorporated by reference, disclose flexible sensors.

Additionally, in-tire sensors are known. For example, WO2021168286A1, the contents of which is hereby incorporated by reference, discloses in-tire sensors.

Further, commercially available WFTs are known to measure the real time forces and moments at a vehicle's wheel hub. These forces and moments can be used as inputs to the car's electronic control unit (ECU), e.g., for control of the anti-lock braking systems (ABS) and electronic stability controls (ESC) and the like, to improve driving safety and vehicle handling. For example, in the publication “Improving the active safety of road vehicles by sensing forces and moments at the wheels,” (Massimiliano Gobbi, Juan C. Botero & Giampiero Mastinu (2008), Vehicle System Dynamics, 46: S1, 957-968) using tire forces and moments as inputs to the ABS was shown to reduce the stopping distance by 10%, and produce a smoother braking action.

However, existing WFTs are typically expensive and heavy. For example, the cost of one Kistler-brand WFT is upwards of $100K, making it more expensive than most cars. The cost of four such sensors (e.g., one per wheel) is impractical. Additionally, a set of four such WFTs weighs about 20-40 kg, which, among other things, reduces fuel efficiency. Other drawbacks, inconveniences, inefficiencies, and issues also exist with current systems and methods.

### SUMMARY

Accordingly, disclosed embodiments address the above, and other, drawbacks, inconveniences, inefficiencies, and issues that exist with current systems and methods. Other advantages and efficiencies of disclosed systems and methods also exist.

As used herein, “flexible,” “extensible,” “compliant,” “deformable,” and the like are used somewhat interchangeably and all mean that some amount of flexing, stretching, compression, twisting, bending, or the like, exists for the described embodiment. As used herein, “extensible” is generally used to collectively mean all of the above.

Disclosed exemplary embodiments include in-tire sensor systems consisting of a contact patch (CP) sensor and a sidewall (SW) sensor each bonded to the interior of a tire to directly sense tire deformation. Embodiments of the CP and SW sensors also may include one or more capacitors, each of which has an electrostatic capacity that is variable due to at least deformation of each capacitor. Embodiments of the sensor systems may also include an electronics unit connected to each capacitor and configured to control the sensors. The electronics unit may be configured to estimate at least one of the parameters of a tire based on the electrostatic capacity of each capacitor.

Also disclosed are exemplary methods of computing tire forces, tire moments and slip angle using the CP and SW sensor signals. Embodiments of the methods also may extract macro features from CP and SW sensor signals. Embodiments of the methods also may choose the most relevant macro features for computing the target tire physical quantity. Other embodiments also exist.

### BRIEF DESCRIPTION OF THE DRAWINGS

FIG. 1 is a cross-sectional view of a portion of a tire with an example sensor module for estimating one or more parameters of the tire in accordance with disclosed embodiments.

FIGS. 2A-2B are schematics of another example sensor module in accordance with disclosed embodiments.

FIG. 3 is a schematic of an example energy generating circuit that may be included in the sensor module of FIGS. 2A-2B in accordance with disclosed embodiments.

FIGS. 4A-4B illustrate another example sensor module in accordance with disclosed embodiments.

FIGS. 5A-5B illustrate embodiments of tire sensor modules positioned inside a tire in accordance with disclosed embodiments.

FIG. 6 illustrates sensor module component (CP and SW) micro-view signals in accordance with disclosed embodiments.

FIG. 7 illustrates sensor module component (CP and SW) macro-view signals in accordance with disclosed embodiments.

FIG. 8 illustrates an experimental setup including a force and moment machine and in-tire sensor modules in accordance with disclosed embodiments.

FIG. 9 illustrates the CP, SW and WFT signals resultant from the experimental setup of FIG. 8.

FIG. 10 illustrates the forces and moments notation for FIG. 9.

FIG. 11 illustrates one workflow example using the CP and SW signals and extracting macro features from them in accordance with disclosed embodiments.

FIG. 12, illustrates calculating the lateral force, F_{y}, using SW signals alone and using both SW and CP signals in accordance with disclosed embodiments.

FIG. 13 illustrates calculating slip angle (SA) using only SW signals and using both CP and SW in accordance with disclosed embodiments.

FIG. 14 illustrates calculating the x-axis moment (Mₓ) using SW signals and using both CP and SW signals in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

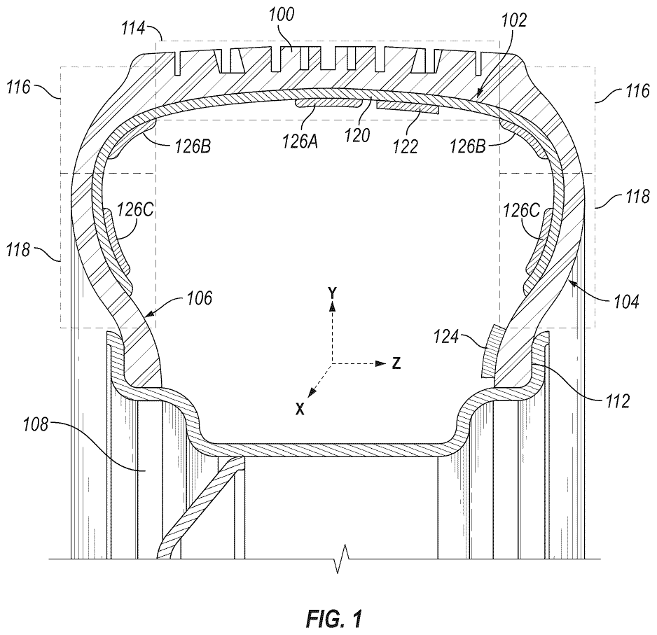

FIG. 1 is cross-sectional view of a portion of a tire 100 with an example sensor module 102 for estimating one or more parameters of the tire 100, arranged in accordance with at least one embodiment described herein. In some embodiments, the tire 100 is a tubeless tire having a tire carcass 104 with an inner surface 106, the tire 100 forming an airtight seal with a wheel 108 to define a reservoir 110 for receipt of a gas, generally air, therein. The tire carcass 104 may have a tire bead 112 which interacts with the wheel 108 to form the airtight seal. In some embodiments, the tire 100 is used with an inner tube disposed within the reservoir 110 to hold a gas such as air, in which case the tire 100 need not form an airtight seal with the wheel 108. The tire carcass 104 may include a tread portion 114, shoulder portions 116, and sidewall portions 118.

The sensor module 102 may be disposed upon the inner surface 106 of the tire 100, on an outer surface of an inner tube disposed within the reservoir 110 when the tire 100 is implemented with the inner tube, or on or at other suitable location(s). The sensor module 102 may generally include a detector patch 120 and an electronics unit 122 connected to the detector patch 120. The sensor module 102 may additionally include or be coupled to an electric power source 124. For example, the electronics unit 122 may be coupled to the electric power source 124 to obtain power for operation.

The detector patch 120 may include one or more sensor regions 126A, 126B, and/or 126C (hereinafter collectively “sensor regions 126” or generically “sensor region 126”). Each of the sensor regions 126 may include one or more capacitors. The detector patch 120 may be applied or coupled to the inner surface 106 such that one or more of the sensor regions 126 is disposed upon, in close proximity, and/or adjacent to the tread portion 114, the shoulder portions 116, and/or the sidewall portions 118. For example, as illustrated in FIG. 1, the sensor region 126A is disposed on, in close proximity to, or adjacent to the tread portion 114, sensor regions 126B are disposed on, in close proximity to, or adjacent to shoulder portions 116, and sensor regions 126C are disposed on, in close proximity to, or adjacent to sidewall portions 118. In some embodiments, adjacent can be within 1 millimeter (mm), 5 mm, 10 mm, 25 mm, or 100 mm of the tread portion 114, shoulder portion 116, or sidewall portion 118 of the tire 100. Alternatively, or additionally, the detector patch 120 may be adhered to the inside of the tread portion 114 (e.g., on the inner surface 106), the inside of the shoulder portion 116 (e.g., on the inner surface 106), and/or the inside of the sidewall portion 118 (e.g., on the inner surface 106).

In FIG. 1, each of the sensor regions 126 is depicted as being located inside a single one of the tread portion 114, the shoulder portion 116, or the sidewall portion 118. Alternatively, or additionally, one or more of the sensor regions 126 may be located inside two or more of the tread portion 114, the shoulder portion 116, or the sidewall portion 118. For example, at least one of the sensor regions 126 may be elongate and may extend across an inside of at least two of the tread portion 114, the shoulder portion 116, or the sidewall portion 118.

The electronics unit 122 is depicted in FIG. 1 as inside the tread portion 114 but more generally may be positioned anywhere on or coupled to the tire 100, the wheel 108, the detector patch 120, and/or the electric power source 124. In some embodiments, the electronics unit 122 includes one or more of a printed circuit board (PCB), one or more voltage and/or current measurement circuits, a transmitter, a receiver, a transceiver, or other components. The electronics unit 122 may be configured to measure one or more parameters of the sensor regions 126 or capacitors therein, estimate one or more tire parameters based on the measurements, transmit the estimated tire parameter(s) to another system or device, and/or transmit the measurements to another system or device to perform the estimation of one or more tire parameters.

The electric power source 124 may include one or more batteries, an energy generating circuit, a receiver coil and circuitry of an inductive charging unit, or other electric power source.

FIG. 1 includes arbitrarily-defined X, Y, Z coordinate axes arranged with the X axis aligned to a longitudinal direction (e.g., the direction the tire 100 moves when rolling forward or backward without any sideslip), the Z axis aligned to a lateral direction (e.g., the direction that is orthogonal to the longitudinal direction and horizontal), and the Y axis aligned to a vertical direction that is orthogonal to the longitudinal and lateral directions. The X, Y, and Z coordinate axis may also be respectively referred to as roll, pitch, and yaw axes.

When a vehicle that includes one or more tires such as the tire 100 is making a turn, it has a tendency to roll, e.g., to rotate about the X axis or the roll axis. For example, when a car is moving through a turn, tires 100 of the car on the inside of the turn (hereinafter the “inside tires 100”), or more particularly, the centers of gravity of the inside tires 100, tend to lift through the turn, while tires 100 of the car on the outside of the turn (hereinafter the “outside tires 100”), or more particularly the centers of gravity of the outside tires 100, tend to depress. This may result in movement of the center of gravity of the inside tires 100 and the outside tires in the XZ plane of FIG. 1.

When the vehicle is accelerating or decelerating, it has a tendency to rotate about the Y axis or the pitch axis. For example, when a rear-wheel drive car is accelerating forward, there is a tendency for the front of the car and thus the front tires 100, or more particularly the centers of gravity of the front tires, to lift up. When the car is moving forward and decelerates or brakes, there is a tendency for the front of the car and thus the front tires 100, or more particularly the centers of gravity of the front tires, to be depressed down. This may result in movement of the centers of gravity of the front tires 100 in the YZ plane of FIG. 1. Further, vertical forces on the tires 100 may vary, e.g., as the vehicle accelerates and decelerates. For example, compared to moving forward with constant velocity, downward vertical forces on the front tires 100 may be lower during accelerations and higher during decelerations.

When the vehicle is struck from the side by another vehicle forward or rearward of the center of gravity of the vehicle, it has a tendency to rotate about the Z axis or the yaw axis. For example, if the vehicle is struck from the side by another vehicle rearward of the center of gravity of the vehicle, and assuming the positive X direction in FIG. 1 is the direction the vehicle is facing, there is a tendency for the rear tires 100 to move laterally in the negative Y direction and a tendency for the front tires 100 to move laterally in the positive Y direction. This may result in movement of the front tires 100 in the XY plane of FIG. 1.

The vertical, longitudinal, and/or lateral forces on the tires 100 of the vehicle and/or other parameters of the tires 100 such as strain, flex, bend, or the like, may vary in these and other circumstances. Embodiments described herein may use one or more sensor modules 102 in one or more tires 100 of vehicles to estimate such tire parameters. These measured tire parameters in combination can comprise a set of leading indicators of the pitch, roll and yaw felt by the vehicle suspension system. Employing a leading indicator should reduce the response lag of an active or semi-active suspension system.

In some embodiments, one or more of the capacitors included in the sensor regions 126 of the sensor module 102 may be layered and/or lamellar. Alternatively, or additionally, the one or more of the capacitors may be flexible, extensible, distensible, and/or deformable. The flexibility, extensibility, distensibility, and/or deformability of the one or more of the capacitors may be at least partially elastic. For example, a capacitor may be elastically deformable if it is capable of experiencing a change in shape under stress or force where the change in shape is reversable after the stress or force is removed.

In some embodiments, the one or more of the capacitors may include a single- or multi-directionally distensible or extensible capacitor. As used herein, multi-directionally distensible or extensible means that the capacitor may be distended or extended in multiple directions relative to its first position on the inner surface 106 of the tire 100. In some embodiments, the capacitor may be distensible or extensible in response to longitudinal, lateral, or vertical forces, or combinations thereof. The capacitor may be disposed upon a first position on the inner surface 106 and, due to distension of the tire 100 under an applied force relative this first position, may be moved or distended from this first position to a second relative position.

In some embodiments, the one or more capacitors and/or the detector patch 120 may be constrained to stretch only in a certain dimension by appropriate addition and/or orientation of elements in the sensor module 102. For example, an anisotropic member may be added to the detector patch 120 which limits deformation along the Y axis while not restricting deformation along the X axis. This may amplify an X axis deformation signal and damping Y axis deformation signal from the detector patch 120. The anisotropic member can be any layer in a stack up of the detector patch 120, including adhesive. As another example the added member may continue to allow bending but restrict stretching. This may be the case where the added member itself is flexible but has limited stretchability.

One or more of the capacitors included in the sensor regions 126 of the sensor module 102 may be elongate; that is, a length of one or more of the capacitors may exceed its width. In some embodiments where the detector patch 120 includes multiple capacitors including a first capacitor and a second capacitor and/or multiple sensor regions 126, the first and second capacitors or first and second sensor regions 126 may be arranged such that a length of the second capacitor or second sensor region 126 is aligned within ±5°, 10°, 15°, 20°, or 30° of a length of the first capacitor or first sensor region 126 or within ±5°, 10°, 15°, 20°, or 30° of a direction orthogonal to the length of the first capacitor or first sensor region 126. In some embodiments, the first and second capacitors and/or first and second sensor regions 126 can be linearly aligned. In some embodiments, multiple capacitors and/or sensor regions 126 of the detector patch 120 can be disposed in a radially parallel plane (e.g., the XY plane of FIG. 1).

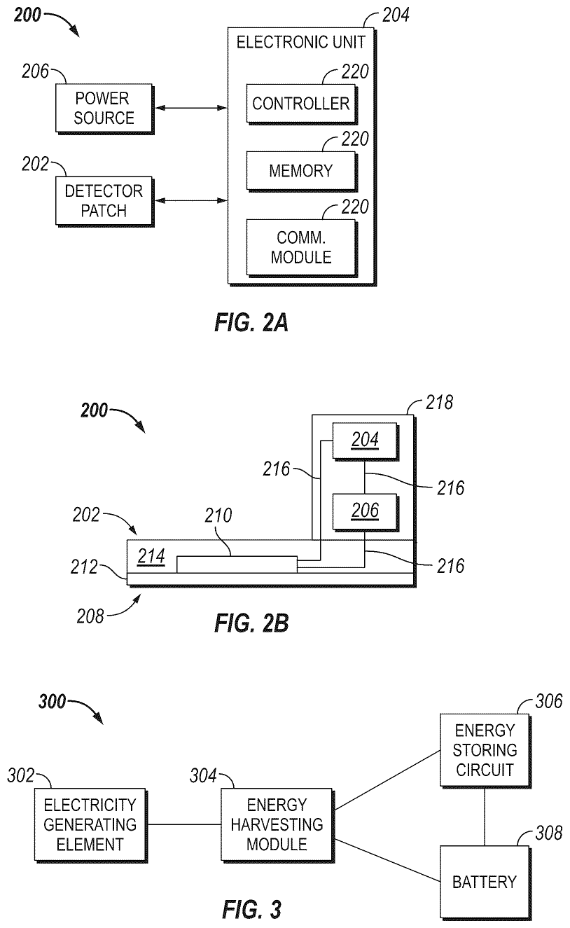

FIGS. 2A-2B are schematics of another example sensor module 200, arranged in accordance with at least one embodiment described herein. The sensor module 200 may include, be included in, or correspond to the sensor module 102 of FIG. 1. For example, the sensor module 102 of FIG. 1 may have a same, similar, or different composition and/or configuration as the sensor module 200 of FIGS. 2A-2B.

As illustrated in FIGS. 2A-2B, the sensor module 200 may generally include a detector patch 202 and an electronics unit 204 and optionally an electric power source 206, the electronics unit 204 connected to the detector patch 202 and the electric power source 206.

The detector patch 202, the electronics unit 204, and the electric power source 206 may respectively include, be included in, or correspond to the detector patch 120, the electronics unit 122, and the electric power source 124 of FIG. 1.

The detector patch 202 may include a mounting surface 208 (FIG. 2B) and one or more sensor regions 210 (FIG. 2B). The mounting surface 208 may be configured to be attached to a surface of a tire or other object and/or may include a lower or bottom surface (FIG. 2B) of the detector patch 202. Alternatively, or additionally, the mounting surface 208 may include an adhesive 212 (FIG. 2B) disposed thereon to adhere the detector patch 202 to a desired position within a tire cavity of a tire or exterior of an inner tube. The adhesive 212 may include thermoplastic adhesive or other suitable adhesive.

The sensor region 210 may generally include a capacitor. In some embodiments, the capacitor and/or the sensor region 210 may be flexible, extensible, distensible, deformable, layered, and/or lamellar. Alternatively, or additionally, the sensor region 210 may be at least partially covered, bound, and/or surrounded by one or more protective layers 214 as part of the detector patch 202. The protective layers 214 may include an elastomeric material such as silicone or the like.

The electric power source 206 may include a battery, an energy generating circuit, an energy harvesting system (EHS) module, a dielectric elastomer generating material, a piezoelectric generating material, and/or a receiver coil and circuitry of an inductive charging unit.

The electronics unit 204 may be in electrical communication with each of the detector patch 202 and the power source 206 via one or more corresponding electrical connectors 216 (FIG. 2B). Alternatively, or additionally, the electronics unit 204 and the electric power source 206 may be mechanically coupled together by epoxy resin and/or may be disposed within a housing or encapsulant 218 (FIG. 2B) that is mechanically coupled to the detector patch 202. The housing or encapsulant 218 may be an electrical, thermal, and/or mechanical insulator. For example, the housing or encapsulant 218 may include a vibration damping material such as platinum silicone flexible foam, a specific example of which includes SOMA FOAMA 25. In another embodiment, the housing 218 may be supported by a vibration isolator mounted on mounting surface 208. The vibration isolator may be or include a spring mechanism, a patterned grid of vibration dampers, a microlattice, or the like. The vibration isolators may be made from molded rubber, metal or a composite thereof. In another embodiment, an electricity generating element (e.g., dielectric elastomer generating material and/or piezoelectric generating material) can be actuated by cyclical deformation of the vibration isolator.

In some embodiments, and as illustrated in FIG. 2A, the electronics unit 204 may include a controller 220, a memory 222, and/or a communication module 224. The controller 220 may be operably coupled to each of the memory 222 and the communication module 224 and may generally be configured to control operation of the sensor module 200. For example, the electronics unit 204 generally and the controller 220 specifically may be configured to perform or control performance of operations including charging each capacitor of the sensor module 200, calculating a variation of electrostatic capacity of each capacitor on discharged charge amount during discharge of each capacitor, and/or estimating at least one tire parameter based on the electrostatic capacity and/or the variation of the electrostatic capacity. In some embodiments, the controller 220 may estimate, compare and/or otherwise analyze one or more tire parameters. The tire parameters may include one or more of: tire internal pressure, strain, angular displacement, temperature, inflation pressure (under and over) friction, hydroplaning portion of contact patch, road classification, uneven tire loads, camber imbalance, vehicle loading, individual tire balance, suspension anomalies, tire anomalies (cracks, delamination, puncture holes), treadwear and tire thickness, tire strain, quick accelerations, quick turns, quick braking, slip angle, slip ratio, camber angle effects, longitudinal force, longitudinal acceleration, longitudinal velocity, lateral force, lateral acceleration, lateral velocity, torque about longitudinal axis, torques about lateral axis, torque about vertical axis, and/or tire rotational speed. In some embodiments the controller 220 estimates the tire rotational speed and the road classification and uses that to modulate the sampling frequency. This may conserve energy in some circumstances while at the same time providing enough data to calculate safety parameters like road classification including hydroplaning at high speeds. For example, the controller 220 may increase sampling rate when it detects a wet road to allow a human driver or an autonomous vehicle to respond faster.

In some embodiments in which the sensor module 200 includes multiple sensor regions 210, the controller 220 may selectively receive data from any or all of the sensor regions 210 or portions thereof. This may facilitate tire parameter analysis while the tire is in motion and/or under the stress of turning. Alternatively, or additionally, this may enable self-testing of the sensor module 200 to identify when one or more sensor regions 210 or the entire sensor module 200 or portion thereof should be replaced. The memory 222 may store data generated by the sensor regions 210 (e.g., raw measurement data or signal), data generated by the controller 220 (e.g., calculated electrostatic capacity or variation of electrostatic capacity, or estimated tire parameter(s)), and/or other data.

Incorporation of an in-sensor computing element, e.g., the controller 220, can reduce the amount of raw data, such as strain and angular displacement data, that may be sent to an external or remote device. This may reduce memory and energy consumption for wireless transmission to the external or remote device and may decrease feedback latency. In some embodiments, each tire of a vehicle includes one or more sensor modules 200 and each of the sensor modules 200 may transmit its data to an on-board computer of the vehicle that, while on the same vehicle, is nevertheless a remote device with respect to each of the sensor modules 200. The on-board computer may generate alarms or other notifications to a driver of the vehicle based on the data received from the sensor modules 200, store the data, perform further processing on the data, report the data to a fleet or vehicle management system, or perform some other operations on, with, or based on the data. In some embodiments, each sensor module 200 may be connected (e.g., networked) to the external or remote system or device in a Local Area Network (LAN), an intranet, an extranet, or the Internet. The external or remote system or device may operate in the capacity of a server or a client machine in a client-server network environment, or as a peer machine in a peer-to-peer (or distributed) network environment. Each sensor module 200 may include or be in communication with a personal computer (PC), a tablet PC, a set-top box (STB), a Personal Digital Assistant (PDA), a cellular telephone, a web appliance, a server, a network router, switch or bridge, vehicular circuitry, vehicular on-board computer or any machine capable of executing a set of instructions (sequential or otherwise) that specify actions to be taken by that sensor module 200. The controller 220 and the communications module 224 may comprise an asset-side active tracking circuit used for asset tracking.

In some embodiments, the controller 220 can selectively reduce the sampling frequency of at least one sensor region 210 when that sensor region 210 is rotated out of contact or outside of the contact patch of the tire to which the sensor module 200 is attached. In some embodiments, the sampling frequency can be increased in proportion to the tire rotational speed. In some embodiments, the controller 220 can selectively utilize capacitive output from specifically located sensor regions 210 to facilitate determination or estimation of spatial displacement, angular displacement, or other tire parameter of selected tire portions.

The controller 220 may include any suitable special-purpose or general-purpose computer, computing entity, or processing device including various computer hardware or software modules and may be configured to execute instructions stored on any applicable computer-readable storage media. For example, the controller 220 may include a processor, a microprocessor, a microcontroller, a digital signal processor (DSP), an application-specific integrated circuit (ASIC), a Field-Programmable Gate Array (FPGA), or any other digital or analog circuitry configured to interpret and/or to execute computer-executable instructions and/or to process data. Although illustrated as a single controller 220, the controller 220 may include any number of controllers configured to, individually or collectively, perform or direct performance of any number of operations described in the present disclosure. In some embodiments, the controller 220 can include a separate or integrated AI chip which can serve as a center for sensor fusion.

In some implementations, the controller 220 may be configured to interpret and/or execute computer-executable instructions and/or process data stored in the memory 222 and/or other data storage. In some implementations, the controller 220 may fetch computer-executable instructions from a persistent data storage and load the computer-executable instructions in a non-persistent storage such as the memory 222. After the computer-executable instructions are loaded into memory 222, the controller 220 may execute the computer-executable instructions.

The memory 222 may include computer-readable storage media for carrying or having computer-executable instructions or data structures stored thereon. Such computer-readable storage media may include any available media that may be accessed by a general purpose or special-purpose computer, such as the controller 220. By way of example, such computer-readable storage media may include tangible or non-transitory computer-readable storage media including Random Access Memory (RAM), Read-Only Memory (ROM), Electrically Erasable Programmable Read-Only Memory (EEPROM), flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the controller 220 to perform or control performance of a certain operation or group of operations.

The communication module 224 may include one or more circuits or devices configured to facilitate communication between the sensor module 200 and one or more external or remote devices. In some embodiments, such circuits or devices may include a transmitter, a receiver, a transceiver, and/or an antenna. For example, the communication module 224 may include one or more wireless chips to communicate wirelessly using any proprietary or standards-based wireless protocol, examples of which include the IEEE 802.11 standards (e.g., WiFi), Bluetooth, Zigbee, and the like.

In some embodiments, the sensor module 200 further includes a microphone. The microphone can be included in a semiconductor chip that may also include the controller 220, for example. In some embodiments, the microphone can determine pressure. In some embodiments, tire strain measurements determined from the sensor region 210 can be compared with the pressure determination from the microphone to dynamically refine the processor pressure determinations. In some embodiments, outputs from at least one, and or all or any of each wheel of a vehicle can be compared with each to detect possible suspension issues. In some embodiments, input from the microphone can be fused with inputs from the detector patch 202 to improve the accuracy of a road classification algorithm.

In some embodiments, the computed end results of the sensor module 200 can be transmitted to an end user recipient. In some embodiments, the end user recipient can be a smartphone. In some embodiments, the end user recipient can be a cloud server. In some embodiments, the end user recipient can be the vehicle itself. In some embodiments, the output can be sent to a processing unit of the vehicle which can modify the vehicle motion, e.g., slow the vehicle down when levels of global tire strain attain certain thresholds. In some embodiments, the output can be sent to a data logger within the vehicle. In some embodiments, the data logger can be part of an on-board computer which compares outputs by the tires and extracts parameters pertinent to the ensemble of tires, e.g., comparing tire wear patterns and recommending specific tire rotation patterns. In some embodiments, the on-board computer may direct specific controller units 220 of corresponding sensor modules 200 to reduce sampling and/or reduce data transmission rates from sensor modules 200 where the power sources 206 have battery or charge levels below a threshold. To compensate, the on-board computer may use data from tires adjacent to extrapolate ensemble information. In some embodiments, the output can be sent to an indicator light to indicate the achievement of a given threshold parameter.

FIG. 3 is a schematic of an example energy generating circuit 300, arranged in accordance with at least one embodiment described herein. The energy generating circuit 300 may include, be included in, or correspond to the electric power source 206 of FIGS. 2A-2B. For example, the electric power source 206 of FIGS. 2A-2B may include some or all of the energy generating circuit 300 of FIG. 3.

The energy generating circuit 300 may include an electricity generating element 302, an EHS module 304, an energy storing circuit 306, and/or a battery 308. The EHS module 304 may be electrically coupled to the electricity generating element 302, the energy storing circuit 306, and/or the battery 308.

The electricity generating element 302 may include a dielectric generating material, a piezoelectric generating material, or other material, system, or device that generates electricity when subject to motion, mechanical stress, or other input, or a combination thereof. In some embodiments, flexing of the electricity generating element 302, e.g., implemented as a piezo flexing film, and or portions of a detector patch that has such materials can generate a charge on the surface of the electricity generating element 302. Suitable material(s) for the electricity generating element 302 may include, e.g., a silicone polymer and a charge generating material, e.g., lead zirconate titanate. In some embodiments, the silicone polymer can include 50 to 90 wt % of the charge generating material. In some embodiments, the electricity generating element 302 may be disposed in close proximity to a tread portion, a shoulder portion, and/or a sidewall portion of a tire.

In some embodiments, the EHS module 304 collects capacitive discharge and/or current generated by the electricity generating element 302. The EHS module 304 may include bridge rectifiers, voltage regulators, and/or an energy buffer capacitor to collect the output of the electricity generating element 302 and generate an electrical output compatible with electronics of a corresponding sensor module and/or vehicle. After accumulating the output above a threshold level, the EHS module 304 may discharge and send the accumulated output to the energy storing circuit 306. In some embodiments, not all of the energy accumulated by the energy buffer capacitor is sent to the energy storing circuit 306; some of that energy can instead be redirected back for use in the electronics unit 204.

In some embodiments, the energy storing circuit 306 includes a battery charging integrated circuit (1C) and/or direct electrical connection to a storage source, e.g., a rechargeable battery 308. An electronics unit, such as the electronics unit 204 of FIGS. 2A-2B, may draw operating power from the battery 308.

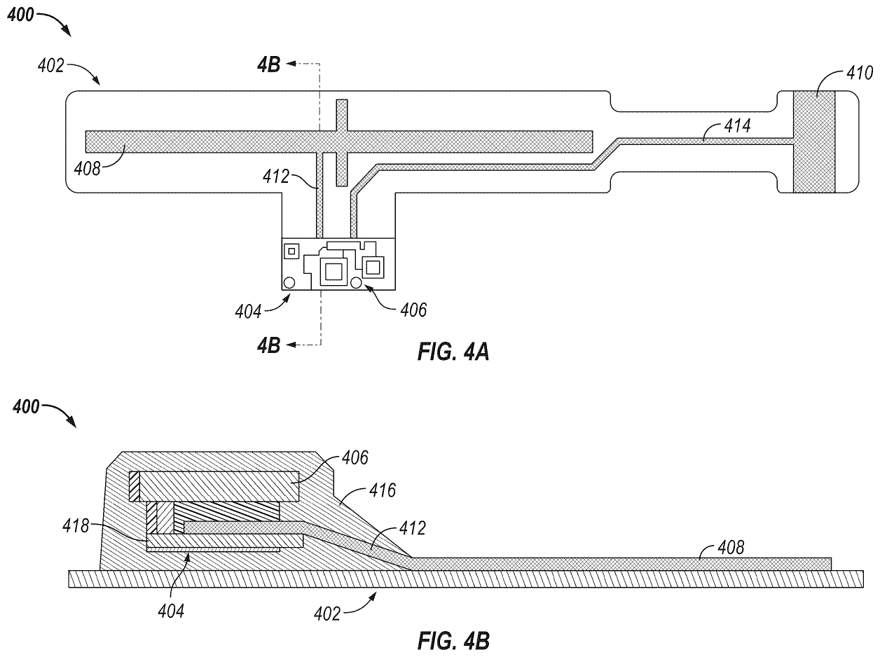

FIGS. 4A-4B illustrate another example sensor module 400, arranged in accordance with at least one embodiment described herein. In particular, FIG. 4A is an overhead view of the sensor module 400 and FIG. 4B is a cross-sectional view of the sensor module 400 in a cutting plane 4B-4B in FIG. 4A. The sensor module 400 may include, be included in, or correspond to other sensor modules herein. For example, the sensor module 102 of FIG. 1 and/or the sensor module 200 of FIGS. 2A-2B may have a same, similar, or different configuration as the sensor module 400 of FIGS. 4A-4B.

As illustrated in FIGS. 4A-4B, the sensor module 400 may generally include a detector patch 402 and an electronics unit 404 and optionally an electric power source 406, the electronics unit 404 connected to the detector patch 402 and the electric power source 406. The detector patch 402, the electronics unit 404, and the electric power source 406 may respectively include, be included in, or correspond to other detector patches, electronics units, and electric power sources herein.

As illustrated in FIG. 4A, the detector patch 402 may include two sensor regions 408, 410, each of which is electrically coupled to the electronics unit 404 by a corresponding electrical trace 412, 414. Each of the sensor regions 408, 410 may include a capacitor with an electrostatic capacity that is variable due to deformation of the capacitor.

As illustrated in FIG. 4B, the electronics unit 404 and the electric power source 406 may be mechanically coupled together by epoxy resin and/or may be disposed within a housing or encapsulant 416 that is mechanically coupled to the detector patch 402. The housing or encapsulant 416 may be an electrical, thermal, and/or mechanical insulator. For example, the housing or encapsulant 416 may include a vibration damping material such as platinum silicone flexible foam, a specific example of which includes SOMA FOAMA 25.

As further illustrated in FIG. 4B, the electronics unit 404 may include a PCB 418 with one or more circuits formed thereon or coupled thereto. Alternatively, or additionally, the PCB 418 may include thereon or coupled thereto one or more voltage and/or current measurement circuits, a transmitter, a receiver, a transceiver, or other components. Analogous to other electronics units described herein, the electronics unit 404 may be configured to measure one or more parameters of the sensor regions 408, 410 or capacitors therein, estimate one or more tire parameters based on the measurements, transmit the estimated tire parameter(s) to another system or device, and/or transmit the measurements to another system or device to perform the estimation of one or more tire parameters.

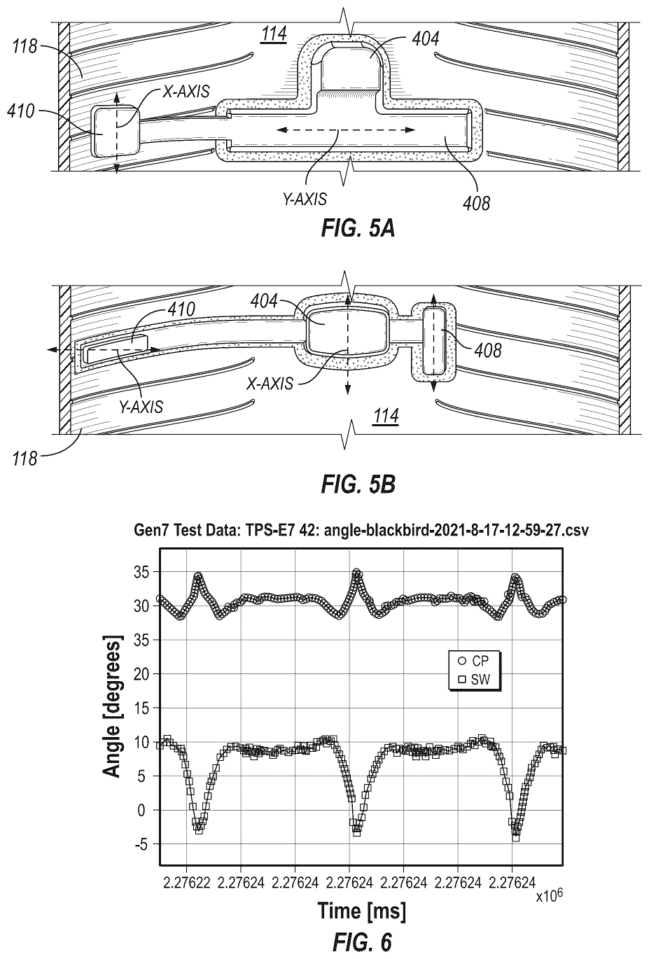

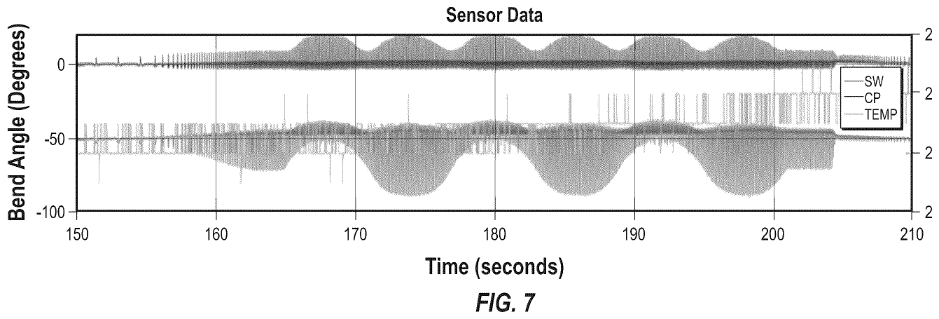

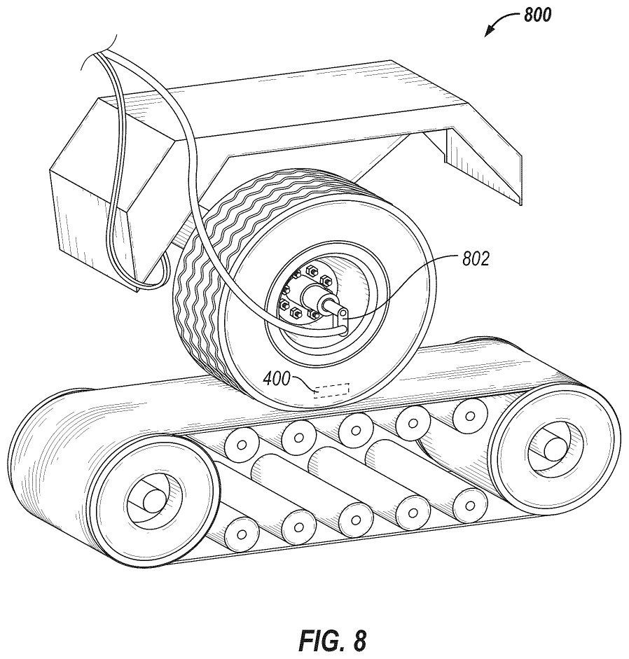

FIGS. 5A-5B illustrate embodiments of tire sensor modules (e.g., modules 200, 400) positioned inside a tire in accordance with disclosed embodiments. The tire sensor module consists of a contact patch (CP) sensor 408 and a sidewall (SW) sensor 410. As illustrated in FIG. 5A, embodiments may have SW sensor 410 generally aligned along the axis of rotation of the tire (e.g., FIG. 1, x-axis) and the CP sensor 408 generally aligned orthogonal to the SW sensor 410 along the lateral axis (e.g., FIG. 1, y-axis). As illustrated in FIG. 5B, the opposite alignment is also possible with SW sensor 410 generally aligned along the y-axis and CP sensor 408 generally aligned along the x-axis. Other orientations are also possible. The sensor components CP 408 and SW 410 produce distinct signals. In micro view (shown in FIG. 6), the waveforms for each signal are distinct. Further, the CP 408 and SW 410 signals in macro view (shown in FIG. 7) are also distinct. The micro and macro signals shown in FIGS. 6-7 were generated when the tire slip angle was varied from −6 to +6 degrees on a force and moment machine 800 (WFT) shown in FIG. 8. The force and moment machine 800 shown in FIG. 8 is equipped with a wheel force transducer 802 and the tire is instrumented with the in-tire sensor modules (e.g., 400) (as indicated schematically in FIG. 8—positioned within tire).

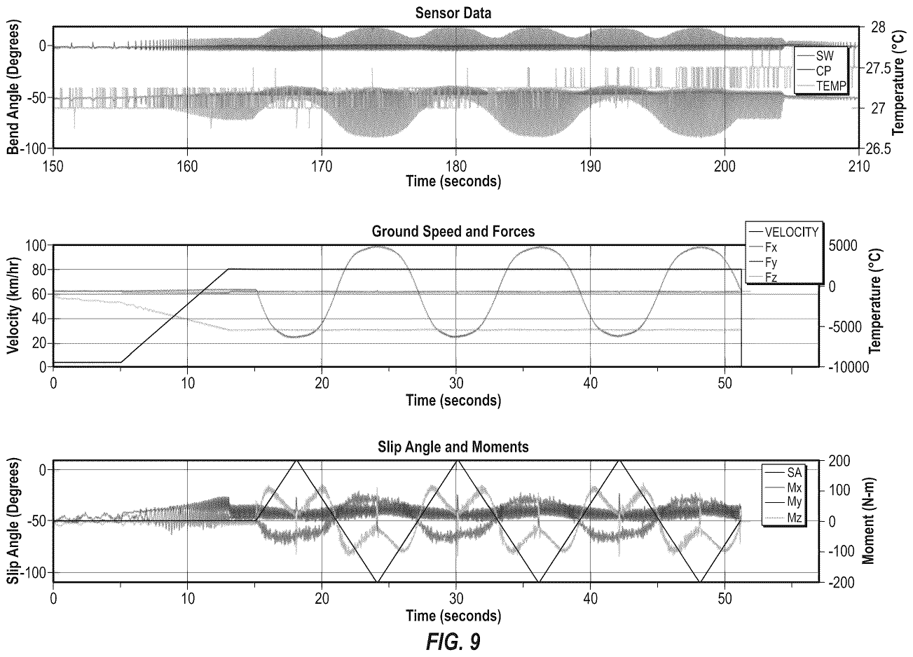

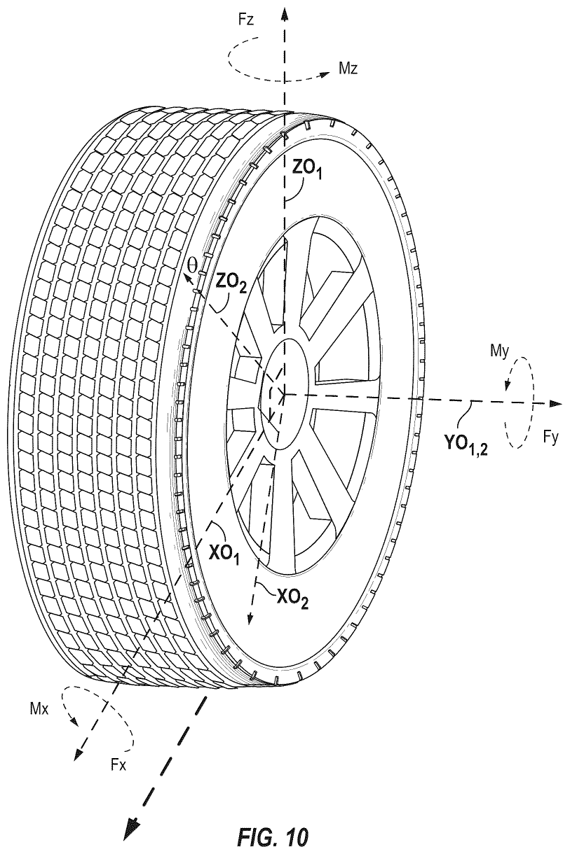

The resulting slip angle, and the forces (Fₓ, F_{y}, F_{z}) and moments (Mₓ, M_{y}, M_{z}) used to drive the slip angle sweep are shown in FIG. 9 and the CP 408, SW 410 and WFT 802 signals are substantially aligned. The forces and moments notation follow the ISO tire coordinate system shown in FIG. 10.

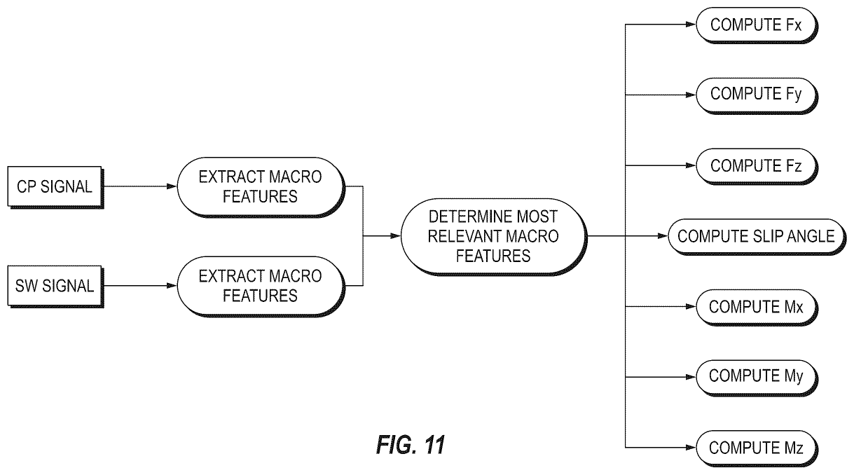

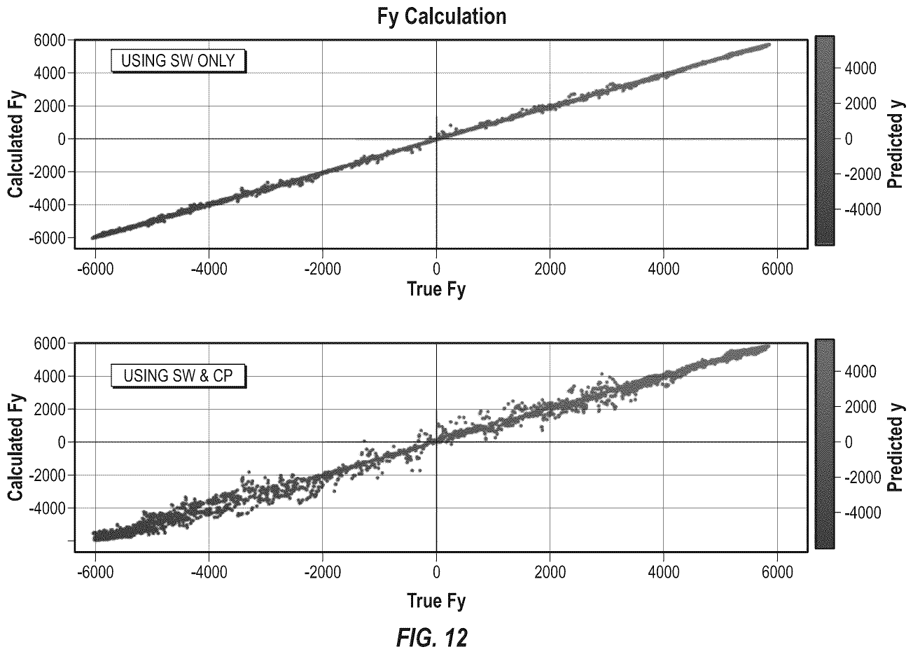

FIG. 11 illustrates one workflow example using the CP 408 and SW 410 signals and extracting macro features from them. These features are then used in several machine learning algorithms (1) to determine the most relevant macro features, and (2) to compute the tire forces, tire moments and slip angle. As will be apparent to those of ordinary skill in the art having the benefit of this disclosure, feature selection is important because results vary depending on the features used by the machine learning model. For example, as illustrated in FIG. 12, when calculating the lateral force, F_{y}, which causes the tire slip angle to change, in some embodiments using SW signals alone is more accurate than using both SW and CP signals.

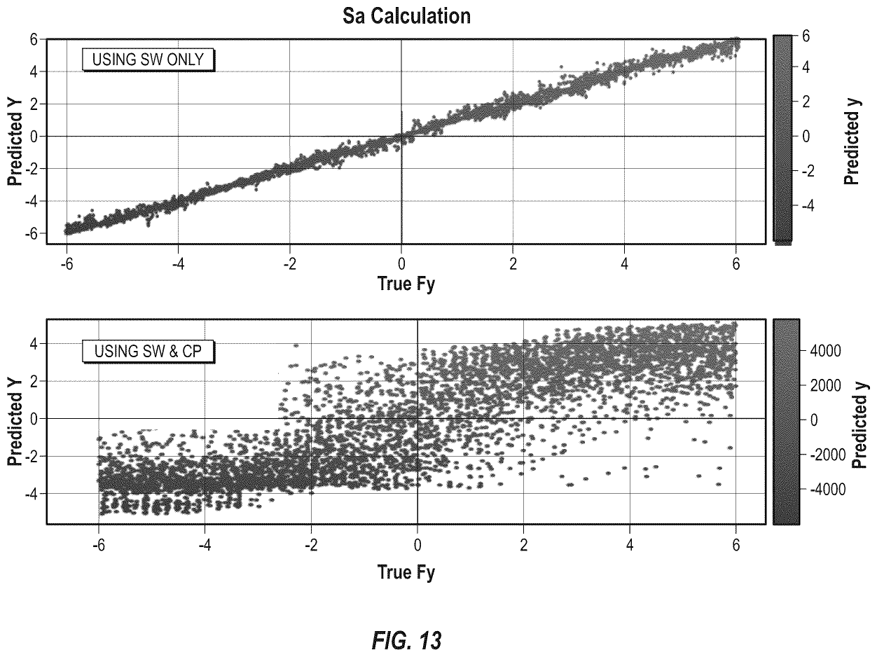

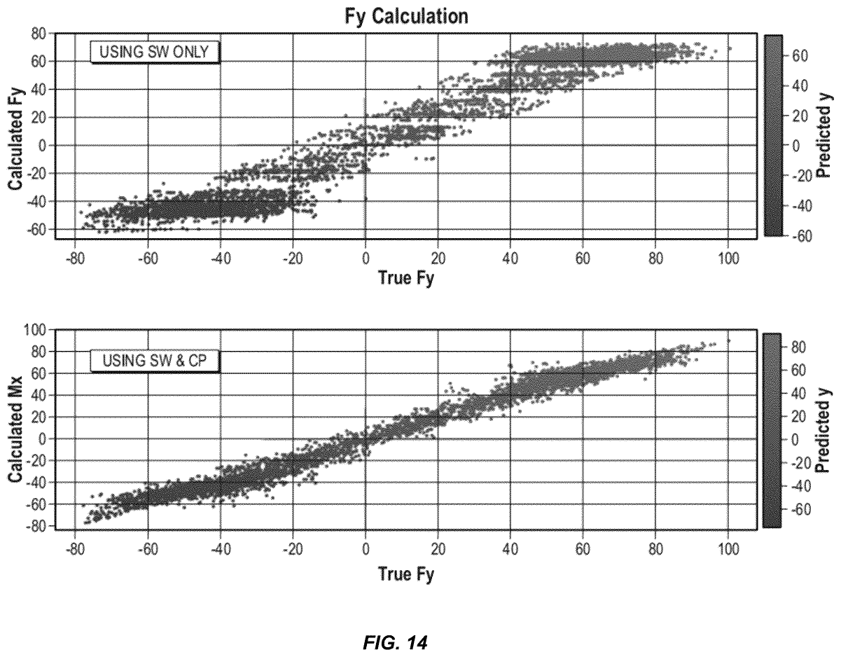

As another example, using only SW signals to calculate the slip angle (SA) is more accurate than including both CP 408 and SW 410 as shown in FIG. 13. This is as expected given the F_{y} result shown in FIG. 12. As will also be understood by those of skill in the art having the benefit of this disclosure, for some physical quantities, using both CP 408 and SW 410 will produce more accurate models than when using just one of these signals. For example, calculated Mx correlated better with experimental Mx when both CP 408 and SW 410 signals are used as shown in FIG. 14. Other embodiments are also possible.

Although various embodiments have been shown and described, the present disclosure is not so limited and will be understood to include all such modifications and variations would be apparent to one skilled in the art.

What is claimed is:

1. A tire, comprising:
a tread portion;
a sidewall portion; and
a sensor module for estimating one or more parameters of the tire, the sensor module comprising:
a detector patch comprising a contact patch and a sidewall patch each comprising one or more extensible capacitors that have an electrostatic capacity that is variable due to at least deformation of the respective one of the contact patch and the sidewall patch; and
a power source;
an electronics unit in electronic communication with the power source and the detector patch and configured to control the sensor module; and
wherein the detector patch is adhered inside the tire so that the contact patch contacts the inside of the tread portion and the sidewall patch contacts the inside of the sidewall portion and the electronics unit is configured to estimate at least one of the parameters by of the tire using the electrostatic capacity of the one or more extensible capacitors.

2. The tire of claim 1 wherein each the one or more extensible capacitors are charged by direct current and a variation of the electrostatic capacity is calculated based at least in part on an amount of discharged charge.

3. The tire of claim 1 wherein the contact patch comprises a length and a width and wherein the length is larger than the width.

4. The tire of claim 1 wherein the sidewall patch comprises a length and a width and wherein the length is larger than the width.

5. The tire of claim 1 wherein the contact patch comprises a length and a width and wherein the length is at least two times the width.

6. The tire of claim 1 wherein the sidewall patch comprises a length and a width and wherein the length is at least two times the width.

7. The tire of claim 1 wherein the detector patch comprises a length and a width and wherein the length is at least two times the width.

8. The tire of claim 1 wherein an axis of the contact patch is oriented in a different direction than an axis of the sidewall patch.

9. The tire of claim 1 wherein an axis of the contact patch is oriented in a substantially orthogonal direction to an axis of the sidewall patch.

10. The tire of claim 9 wherein the axis of the contact patch is oriented substantially parallel to a direction of travel of the tire.

11. The tire of claim 9 wherein the axis of the contact patch is oriented substantially orthogonal to a direction of travel of the tire.

12. A sensor module for estimating one or more parameters of a tire, the sensor module comprising:
a detector patch comprising a contact patch and a sidewall patch each comprising one or more extensible capacitors that have an electrostatic capacity that is variable due to at least deformation of the respective one of the contact patch and the sidewall patch; and
a power source;
an electronics unit in electronic communication with the power source and the detector patch and configured to control the sensor module; and
wherein the detector patch is configured to be adhered to an inside of a tire so that the contact patch contacts an inside of a tread portion and the sidewall patch contacts an inside of a sidewall portion and the electronics unit is configured to estimate at least one of the parameters by of the tire using the electrostatic capacity of the one or more extensible capacitors.

13. The sensor module of claim 12 wherein each the one or more extensible capacitors are charged by direct current and a variation of the electrostatic capacity is calculated based at least in part on an amount of discharged charge.

14. The sensor module of claim 12 wherein the contact patch comprises a length and a width and wherein the length is larger than the width.

15. The sensor module of claim 12 wherein the sidewall patch comprises a length and a width and wherein the length is larger than the width.

16. The sensor module of claim 12 wherein the contact patch comprises a length and a width and wherein the length is at least two times the width.

17. The sensor module of claim 12 wherein the sidewall patch comprises a length and a width and wherein the length is at least two times the width.

18. The sensor module of claim 12 wherein the detector patch comprises a length and a width and wherein the length is at least two times the width.

19. The sensor module of claim 12 wherein an axis of the contact patch is oriented in a different direction than an axis of the sidewall patch.

20. The sensor module of claim 12 wherein an axis of the contact patch is oriented in a substantially orthogonal direction to an axis of the sidewall patch.
